(19) United States
(12) Patent Application Publication
(10) Pub. No.: US 2026/0117984 A1
(43) Pub. Date: Apr. 30, 2026

(54) COOKING APPLIANCE

(71) Applicant: SAMSUNG ELECTRONICS CO., LTD., Suwon-si (KR)

(72) Inventors: Dongwoo SHIN, Suwon-si (KR); Myoungkeun KWON, Suwon-si (KR); Hooijoong KIM, Suwon-si (KR); Younghoon WOO, Suwon-si (KR)

(73) Assignee: SAMSUNG ELECTRONICS CO., LTD., Suwon-si (KR)

(21) Appl. No.: 19/412,116

(22) Filed: Dec. 8, 2025

Related U.S. Application Data
(63) Continuation of application No. PCT/KR2024/009842, filed on Jul. 10, 2024.

(30) Foreign Application Priority Data
Aug. 31, 2023 (KR) 10-2023-0115787

(51) Int. Cl. F24C 15/10; F24C 15/00; H05B 6/12

(52) U.S. Cl. CPC F24C 15/105; F24C 15/006; H05B 6/1263

(57) ABSTRACT

A cooking appliance may include: an upper plate on which a cooking vessel is placeable; a lower plate below the upper plate, and including: electrical components, and a heat sink configured to dissipate heat generated by the electrical components; a sheet coil on the lower plate and forming a gap with the upper plate; a scroll including: an inlet, an outlet, a lower scroll forming a lower flow path from the inlet and along the heat sink, and an upper scroll forming an upper flow path from the inlet and through the gap; and a fan within the scroll with blades having an expansion angle greater in the upper flow path than in the lower flow path, to flow air of which a portion flows along the lower flow path to cool the heat sink, and a portion flows along the upper flow path to cool the sheet coil.

### CROSS-REFERENCE TO RELATED APPLICATIONS

This is a continuation application, under 35 U.S.C. § 111(a), of International Application No. PCT/KR2024/009842, filed Jul. 10, 2024, which claims priority under 35 U.S.C. § 119 to Korean Patent Application No. 10-2023-0115787, filed Aug. 31, 2023, in the Korean Intellectual Property Office, the disclosures of which are incorporated herein in their entireties by reference.

### TECHNICAL FIELD

The disclosure relates to a cooking appliance capable of simultaneously dissipating heat through a sheet coil and a heat sink.

### BACKGROUND ART

In general, a cooking appliance is an appliance for heating and cooking an object to be cooked, such as food, and that may provide a number of functions related to cooking, such as heating, defrosting, drying, and sterilizing the object to be cooked. The cooking appliance may include a cooktop that uses electricity or gas to heat a cooking vessel containing food.

For example, a gas cooktop, a type of a gas stove, is a device that uses gas to cook food by turning a lever to ignite and burn gas from a small generator, generating heat and cooking food with the heat.

In addition, an electric cooktop, a type of an induction, is a device that uses electricity to generate an electromagnetic field in an internal coil and induces an eddy current in a cooking vessel using the principle of electromagnetic induction to generate heat and cook food with the heat.

### DISCLOSURE

### Technical Problem

One aspect of the present disclosure provides a cooking appliance capable of simultaneously dissipating heat from a sheet coil and a heat sink using one fan.

Further, one aspect of the present disclosure provides a cooking appliance in which an interior of a scroll, which forms a flow path for air drawn in by a fan to dissipate heat from a sheet coil and a heat sink, may be divided into a lower flow path and an upper flow path.

Further, one aspect of the present disclosure provides a cooking appliance in which scrolls are divided into a lower scroll and an upper scroll having different structures so that expansion angles of a fan in a lower flow path and an upper flow path are divided by a divider.

Further, one aspect of the present disclosure provides, a cooking appliance in which in order to make an expansion angle of a fan in an upper flow path larger than in a lower flow path, a length in a radial direction from the center of a fan in the upper flow path is longer than a length in the radial direction from the center of the fan in the lower flow path.

Technical tasks to be achieved in this document are not limited to the technical tasks mentioned above, and other technical tasks not mentioned will be clearly understood by those skilled in the art from the description below.

### Technical Solution

In accordance with the present disclosure, a cooking appliance may include: an upper plate on which a cooking vessel is placeable; a lower plate below the upper plate, and including: a discharge hole, electrical components, and a heat sink configured to dissipate heat generated by the electrical components; a sheet coil on the lower plate, and spaced apart from the upper plate so as to form a gap between the sheet coil and the upper plate, the sheet coil configured to generate a magnetic field to heat the cooking vessel; a scroll including: an inlet, an outlet, a lower scroll on a lower portion of the scroll and at least partially forming a lower flow path from the inlet and along the heat sink, and an upper scroll on an upper portion of the scroll and at least partially forming an upper flow path from the inlet and through the gap; and a fan within the scroll, the fan including blades having a first expansion angle in the lower flow path and a second expansion angle greater than the first expansion angle in the upper flow path, the fan operable to generate a flow of air from the inlet to the discharge hole, wherein the fan and the scroll are configured such that, with the fan operated to generate the flow of air, a first portion of the flow of air is guided by the lower scroll along the lower flow path to remove the heat dissipated by the heat sink through the discharge hole, and a second portion of the flow of air is guided by the upper scroll along the upper flow path to remove heat generated by the sheet coil through the discharge hole.

The lower scroll may include a lower installation portion in which the fan is installed and which may form at least a portion of a first lower flow path that is a portion of the lower flow path, the upper scroll may include an upper installation portion in which the fan is installed and which may form at least a portion of a first upper flow path that is a portion of the upper flow path, a length of the first upper flow path from a center of the fan in a radial direction of the fan may be longer than a length of the first lower flow path from the center of the fan in the radial direction.

The lower flow path may include the outlet, and with the fan operated to generate the flow of air, air may be drawn into the inlet and the first portion of the flow of air may include at least a portion of the air drawn into the inlet which may be discharged through the outlet to the heat sink.

The scroll may further include an intake portion including the inlet and that may be coupled to the lower scroll.

The lower scroll may include: a lower installation portion to which the intake portion may be coupled and in which the fan is installed, and a lower connection duct connected to the lower installation portion and that may include the outlet.

The scroll may further include a divider, and the lower flow path may include: a first lower flow path at least partially formed by the lower installation portion and the divider, and a second lower flow path that connects the first lower flow path and the outlet, the second lower flow path may be at least partially formed by the lower connection duct and the divider.

The cooking appliance may further include: a guide duct connected to the lower connection duct and on an upper portion of the heat sink, wherein the guide duct forms a guide flow path that may be part of the lower flow path and the guide duct may be configured such that, with the fan operated to generate the flow of air, the air discharged through the outlet may be guided by the guide duct to the heat sink to remove the heat dissipated by the heat sink.

A first flow path may include the lower flow path and the guide flow path, and the first flow path may be configured to remove the heat dissipated by the heat sink.

The discharge hole may be through a lower surface of the lower plate, and the discharge hole may be configured such that, with the fan operated to generate the flow of air, at least a portion of the first portion of the flow of air removes the heat dissipated by the heat sink and may be discharged to an outside of the cooking appliance through the discharge hole.

The upper scroll may include: an upper installation portion in which the fan is installed, an upper connection duct connected to the upper installation portion, and an opening in the upper connection duct, the opening configured such that, with the fan operated to generate the flow of air, at least a portion of the second portion of the flow of air may be discharged through the opening to the electrical components to remove heat generated by the electrical components.

The scroll may further include a divider, and the upper flow path may include: a first upper flow path at least partially formed by the upper installation portion and the divider, and a second upper flow path that connects the first upper flow path and the gap, the second upper flow path may be at least partially formed by the upper connection duct and the divider.

The lower plate may further include a sheet coil seating plate on which the sheet coil may be seated and through which the discharge hole may be formed.

The upper flow path may include the discharge hole, and with the fan operated to generate the flow of air, air may be drawn into the inlet and the second portion of the flow of air may include at least a portion of the air drawn into the inlet which may be discharged through the discharge hole into the gap.

A second flow path may include the upper flow path and the gap, and the second flow path may be configured to remove the heat generated by the sheet coil.

The discharge hole may be a first discharge hole, the lower plate may further include a second discharge hole through a side wall of the lower plate, and the second discharge hole may be configured such that, with the fan operated to generate the flow of air, a first part of the second portion of the flow of air removes the heat generated by the sheet coil, a second part of the second portion of the flow of air passes through the opening and removes the heat generated by the electrical components, and the first part and the second part are discharged to an outside of the cooking appliance through the second discharge hole.

According to an embodiment of the present disclosure, a cooking appliance includes an upper plate on which a cooking vessel is placed, a lower plate disposed on a lower portion of the upper plate to include a discharge hole and including a plurality of electrical components and a heat sink for dissipating heat generated in the plurality of electrical components, a sheet coil disposed on the lower plate to form a gap with the upper plate, a scroll having an inlet and an outlet and forming a flow path for dissipating heat from the sheet coil and the heat sink by discharging air drawn in through the inlet to the discharge hole and the outlet, and a fan disposed within the scroll to generate an intake force. The flow path may include a lower flow path disposed on a lower portion of the scroll and allowing the air drawn into the inlet may be discharged into the outlet to dissipate heat from the heat sink, and an upper flow path disposed on an upper portion of the lower flow path and allowing the air drawn into the inlet may be discharged into the outlet to dissipate heat from the sheet coil.

### DESCRIPTION OF DRAWINGS

FIG. 1 is a view illustrating a cooktop of a cooking appliance according to an embodiment, viewed from the top.

FIG. 2 is a view illustrating the cooktop of the cooking appliance shown in FIG. 1 from another direction.

FIG. 3 is a view illustrating the cooktop of the cooking appliance according to an embodiment from a bottom view.

FIG. 4 is a view illustrating an upper plate separated from the cooktop of the cooking appliance according to an embodiment.

FIG. 5 is a view illustrating the cooktop of the cooking appliance according to an embodiment, with a sheet coil separated from a sheet coil seating plate on a lower plate.

FIG. 6 is a view illustrating the cooktop of the cooking appliance according to an embodiment, with the lower plate separated from the sheet coil seating plate.

FIG. 7 is a view illustrating a separated guide duct shown in FIG. 5.

FIG. 8 is a view illustrating a lower scroll and an upper scroll of a scroll coupled together, according to an embodiment.

FIG. 9 is a view illustrating the lower scroll and the upper scroll of the scroll decoupled, according to an embodiment.

FIG. 10 is a plan view illustrating a state in which the lower and upper scrolls are coupled, according to an embodiment.

FIG. 11 is a cross-sectional view taken along line A-A′ of FIG. 8.

FIG. 12 is a cross-sectional view illustrating an interior of the scroll divided into a lower flow path and an upper flow path by a divider, according to an embodiment.

FIG. 13 is a cross-sectional view of the cooktop of the cooking appliance according to an embodiment.

FIG. 14 is a cross-sectional view illustrating a flow of air that is drawn into an inlet to be moved along a first flow path to dissipate heat form a heat sink, according to an embodiment.

FIG. 15 is a view illustrating a flow of air that is drawn into the inlet to be moved along a second flow path and then discharged after dissipating heat from the sheet coil, according to an embodiment.

### MODES OF THE INVENTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “primary”, “secondary”, etc., may simply be used to distinguish an element from other elements, but is not limited to another aspect (e.g., importance or order) of elements.

In the following detailed description, the terms of “front”, “forward”, “rear”, “backward”, “top”, “bottom”, “upper”, “lower”, “left”, and “right” may be defined by the drawings, but the shape and the location of the component is not limited by the term.

The terms “including”, “having”, and the like are used to specify features, numbers, steps, operations, elements, components, or combinations thereof, but do not preclude the presence or addition of one or more of the features, numbers, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

Hereinafter, various embodiments according to the disclosure will be described in detail with reference to the accompanying drawings.

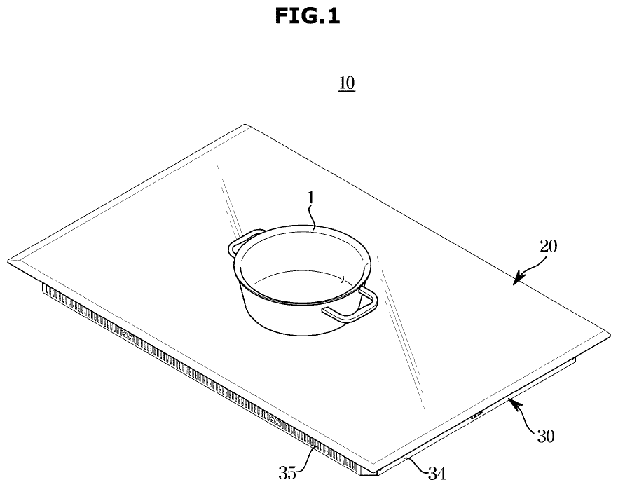

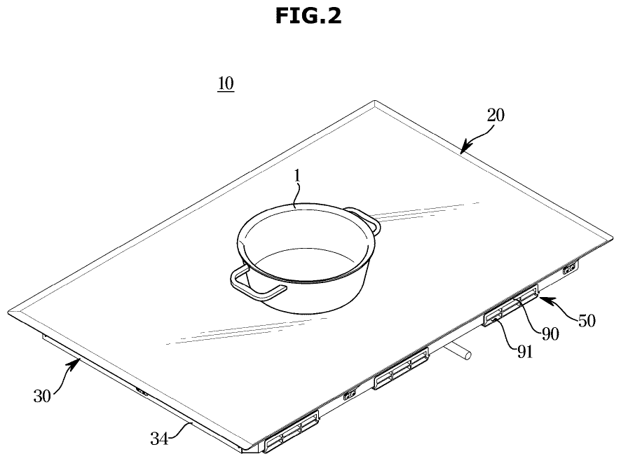

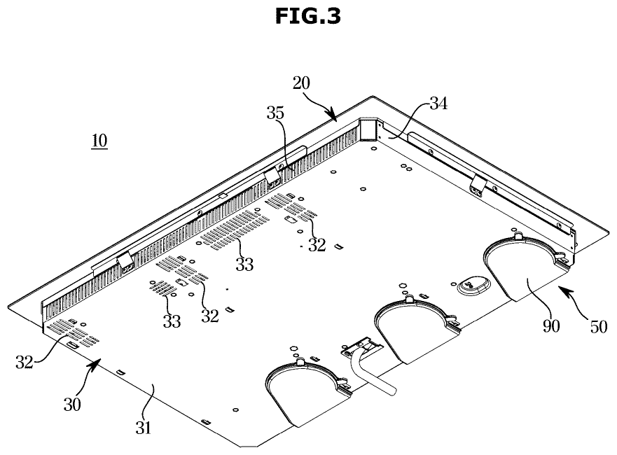

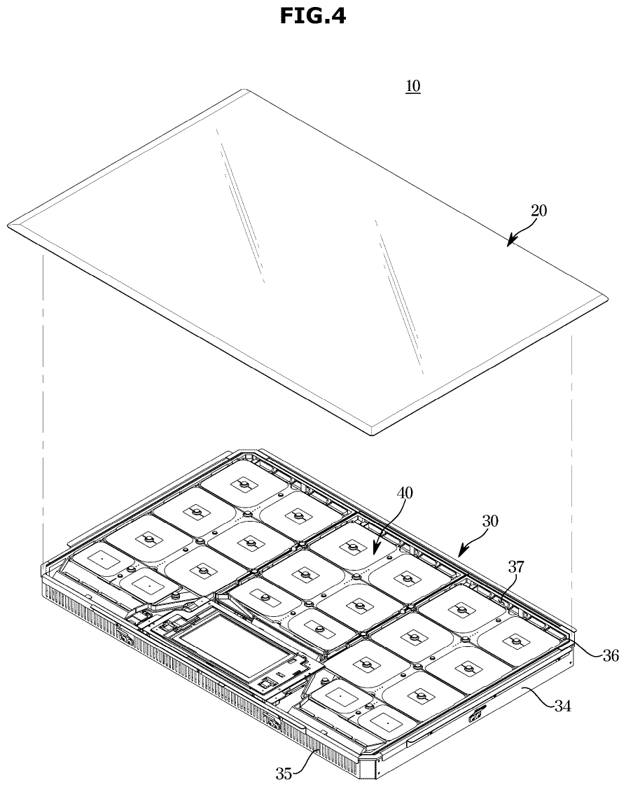

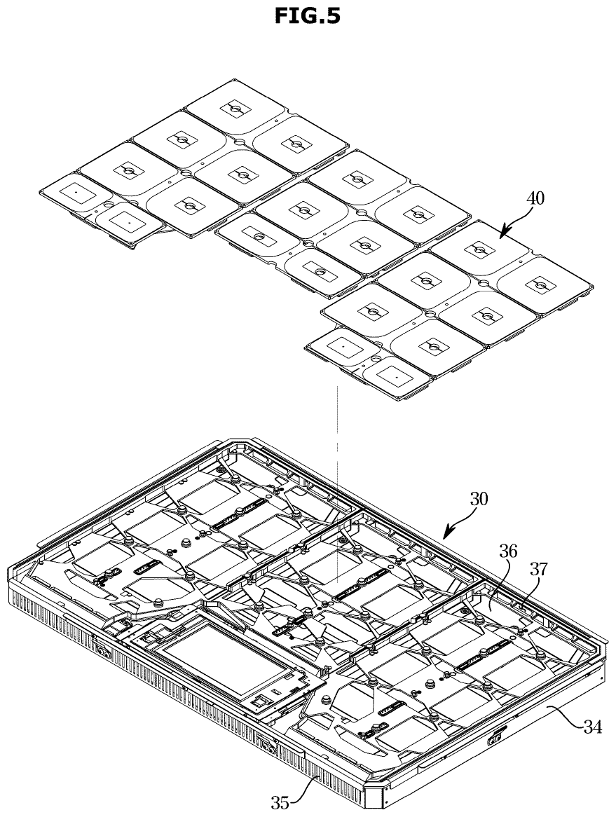

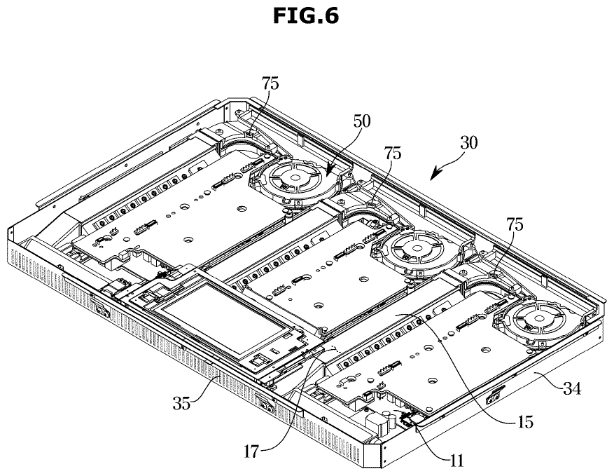

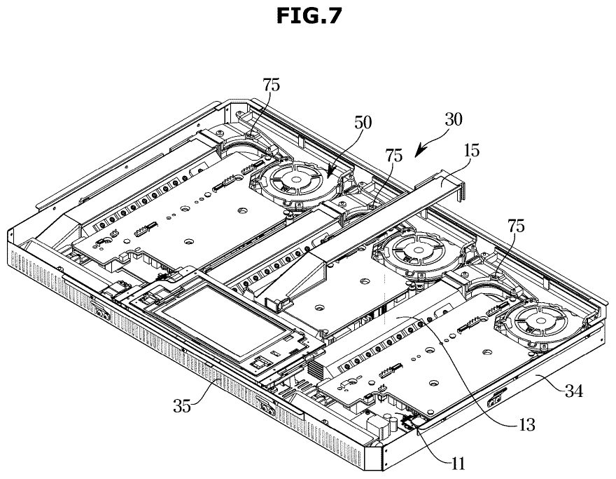

FIG. 1 is a perspective view illustrating a cooktop of a cooking appliance according to an embodiment, viewed from the top. FIG. 2 is a perspective view illustrating the cooktop of the cooking appliance shown in FIG. 1 from another direction. FIG. 3 is a perspective view illustrating the cooktop of the cooking appliance according to an embodiment from a bottom view. FIG. 4 is a view illustrating an upper plate separated from the cooktop of the cooking appliance according to an embodiment. FIG. 5 is a view illustrating the cooktop of the cooking appliance according to an embodiment, with a sheet coil separated from a sheet coil seating plate on a lower plate. FIG. 6 is a view illustrating the cooktop of the cooking appliance according to an embodiment, with the lower plate separated from the sheet coil seating plate. FIG. 7 is a view illustrating a separated guide duct shown in FIG. 5.

As shown in FIGS. 1 to 7, the cooking appliance may include an induction, which is an electric cooktop that uses electricity. The cooking appliance may include a cooktop 10. The cooktop 10 may be an induction, which is an electric cooktop. The cooktop 10 includes an upper plate 20 on which a cooking vessel 1 is placed. The upper plate 20 may be provided such that the cooking vessel 1 is placed thereon. The upper plate 20 may be made of a glass material, for example, ceramic glass.

The cooktop 10 includes a lower plate 30 disposed on a lower portion of the upper plate 10. The lower plate 30 may be arranged below the upper plate 20. The lower plate 30 may be arranged to have a rectangular shape. The lower plate 30 may include a lower surface 31 and a side wall 34. A space may be formed inside the lower plate 30 by the lower surface 31 and the side walls 34. A plurality of electrical components 11 and a heat sink 13 may be provided in the space inside the lower plate 30. The plurality of electrical components 11 and the heat sink 13 may be disposed on an upper portion of the lower surface 31. When the cooktop 10 is operated, heat may be generated in the plurality of electrical components 11, and the heat sink 13 may be disposed next to the plurality of electrical components 11 to dissipate the heat generated in the plurality of electrical components 11.

On an upper portion of the plurality of electrical components 11 and the heat sink 13 arranged in the space inside the lower plate 30, a sheet coil 40 is disposed. The sheet coil 40 may be applied with a current that varies in magnitude over time. When the current is applied to the sheet coil 40, a magnetic field may be formed around the sheet coil 40. As the current applied to the sheet coil 40 varies, the magnetic field formed around the sheet coil 40 may also vary. An eddy current may flow from a surface of the cooking vessel 1 placed on the upper plate 20 due to the change in the magnetic field, and the cooking vessel 1 may be heated by the eddy current.

A plurality of discharge holes 32, 33, and 35 may be provided in the lower surface 31 and the side walls 34 of the lower plate 30. Air drawn in through an inlet 91 formed in an intake portion 90 of a scroll 50 may dissipate the heat of the plurality of electrical components 11, the heat sink 13, and the sheet coil 40, and then be discharged to the outside through the plurality of discharge holes 32, 33, and 35 arranged in the lower surface 31 and the side walls 34.

The plurality of discharge holes 32, 33, and 35 may include the first discharge hole 32 formed on the lower surface 31 of the lower plate 30. The first discharge hole 32 may be formed of a plurality of holes. Air that is drawn in through the inlet 91 formed in the intake portion 90 of the scroll 50 and dissipates heat from the heat sink 13 may be discharged to the outside through the first discharge hole 32. The number of first discharge holes 32 may correspond to the number of heat sinks 13. To dissipate heat from the heat sink 13 more efficiently, a guide duct 15 may be provided at an upper portion of the heat sink 13. The air drawn in through the inlet 91 formed in the intake portion 90 of the scroll 50 may pass through a guide flow path 17 formed within the guide duct 15 and dissipate heat from the heat sink 13. A flow of air that is drawn in through the inlet 91 formed in the intake portion 90 of the scroll 50 to dissipate heat from the heat sink 13 and then discharged to the outside through the first discharge holes 32 will be described in detail below.

The plurality of discharge holes 32, 33, and 35 may include the second discharge hole 35 formed on the side wall 34 of the lower plate 30. The second discharge hole 35 may be formed of a plurality of holes. Air that is drawn in through the inlet 91 formed in the intake portion 90 of the scroll 50 and dissipates heat from the sheet coil 40 may be discharged to the outside through the second discharge holes 35. More specifically, the air that is drawn in through the inlet 91 formed in the intake portion 90 of the scroll 50 and dissipates heat from the sheet coils 40 disposed on the left and right sides may be discharged to the outside through the second discharge hole 35. In addition, air that is drawn in through the inlet 91 formed in the intake portion 90 of the scroll 50 to cool the plurality of electrical components 11 may be discharged to the outside through the second discharge holes 35. A flow of air that is drawn in through the inlet 91 formed in the intake portion 90 of the scroll 50 to dissipate heat from the sheet coil 40 disposed on the left and right sides and the plurality of electrical components 11 and then discharged to the outside through the second discharge holes 35 will be described in detail below.

The plurality of discharge holes 32, 33, and 35 may include the third discharge hole 33 formed on the lower surface 31 of the lower plate 30. The third discharge hole 33 may be formed of a plurality of holes. Air that is drawn in through the inlet 91 formed in the intake portion 90 of the scroll 50 to cool the sheet coil 40 may be discharged to the outside through the third discharge holes 33. More specifically, the air that is drawn in through the inlet 91 formed in the intake portion 90 of the scroll 50 to cool the centrally disposed sheet coil 40 may be discharged to the outside through the third discharge holes 33. A flow of air that is drawn in through the inlet 91 formed in the intake portion 90 of the scroll 50 to dissipate heat from the centrally placed sheet coil 40 and then discharged to the outside through the third discharge hole 33 will be described in detail below.

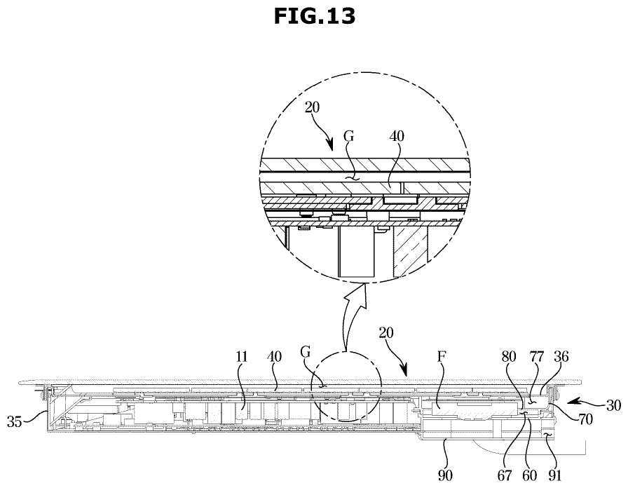

To ensure that the sheet coil 40 is disposed on an upper portion of the plurality of electrical components 11 and the heat sink 13, the lower plate 30 may include a sheet coil seating plate 36 on which the sheet coil 40 is seated. The sheet coil seating plate 36 may be provided on the upper portion of the plurality of electrical components 11 and the heat sink 13. The sheet coil 40 seated on the sheet coil seating portion 36 may be arranged to form a gap G with the upper plate 20. The gap G may be a space between the sheet coil 40 and the upper plate 20. In the gap G, which is the space between the sheet coil 40 and the upper plate 20, no structures obstructing the flow of air may be arranged to allow the air to flow smoothly. The gap G formed between the upper plate 20 and the sheet coil 40 may allow air to flow to dissipate heat from the sheet coil 40. A flow of air that is drawn in from the outside to pass through the gap G formed between the upper plate 20 and the sheet coil 40 to dissipate heat from the sheet coil 40 will be described in more detail below (see FIG. 13).

The sheet coil seating plate 36 on which the sheet coil 40 is seated may include a discharge hole 37. The discharge hole 37 may be provided in a plurality. The discharge holes 37 may allow air drawn in through the inlet 91 formed in the intake portion 90 of the scroll 50 to be discharged through the gap G formed between the upper plate 20 and the sheet coil 40 for heat dissipation of the sheet coil 40. A detailed description of a flow of air drawn in through the inlet 91 formed in the intake portion 90 of the scroll 50 and discharged to the gap G formed between the upper plate 20 and the sheet coil 40 through the discharge holes 37 will be described below.

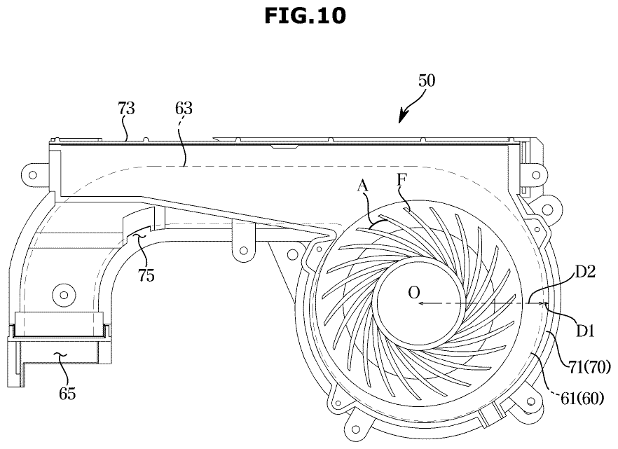

The scroll 50 on which a fan F is installed may be provided on the lower plate 30. The fan F provided inside the scroll 50 may generate an intake force to draw in air from the outside. The fan F may be configured as a turbo fan (see FIG. 10).

The scroll 50 may form flow paths 67 and 77 that direct air into the plurality of electrical components 11, the heat sink 13, and the sheet coil 40 so that the air drawn in by the fan F dissipates heat from plurality of electrical components 11, the heat sink 13, and the sheet coil 40. The number of scrolls 50 may correspond to the number of heat sinks 13 (see FIG. 10).

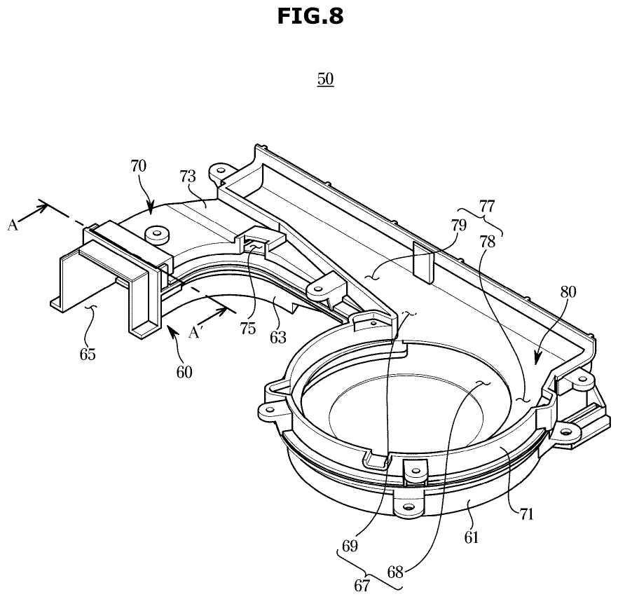

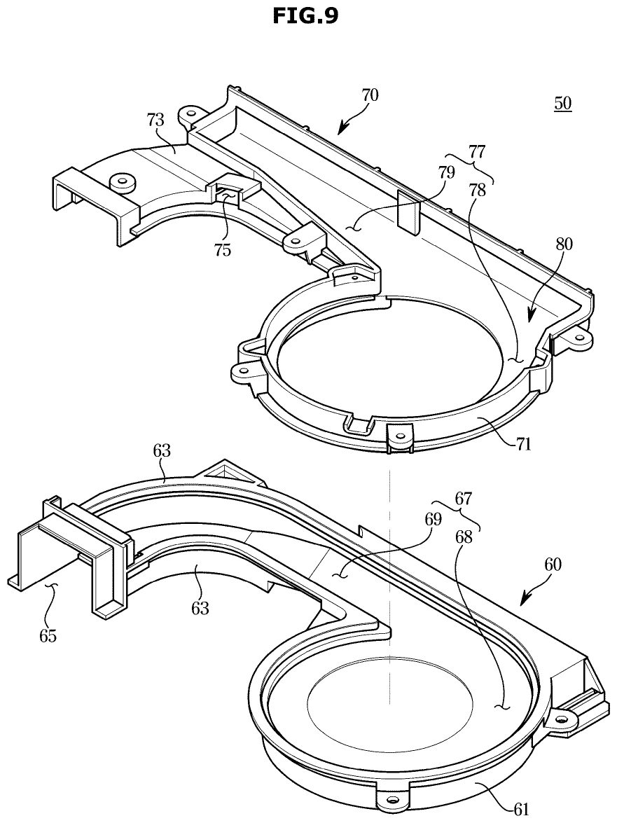

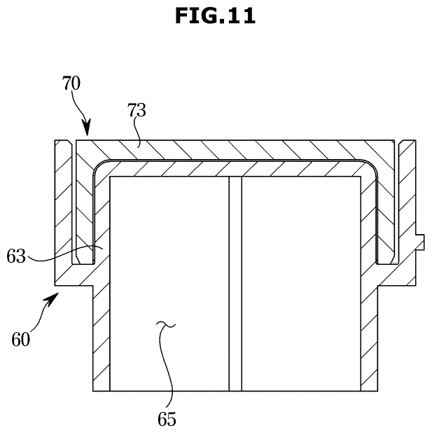

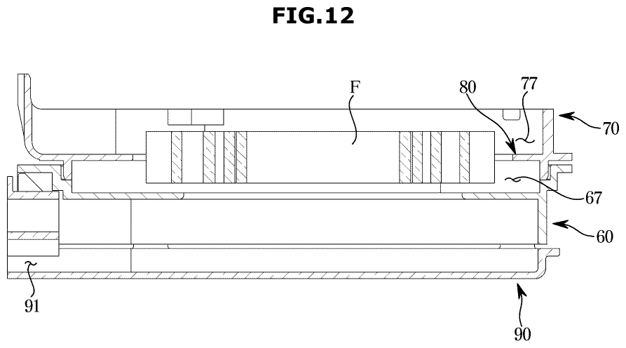

FIG. 8 is a view illustrating a lower scroll and an upper scroll of the scroll coupled together, according to an embodiment. FIG. 9 is a view illustrating the lower scroll and the upper scroll of the scroll decoupled, according to an embodiment. FIG. 10 is a plan view illustrating a state in which the lower scroll and the upper scroll are coupled, according to an embodiment. FIG. 11 is a cross-sectional view taken along line A-A′ of FIG. 8. FIG. 12 is a cross-sectional view showing an interior of the scroll divided into a lower flow path and an upper flow path by a divider, according to an embodiment.

As shown in FIGS. 8 to 12, the scroll 50 includes the inlet 91 through which air is drawn in, and an outlet 65 through which the air drawn in through the inlet 91 is discharged. The scroll 50 includes a lower scroll 60 disposed on a lower portion of the scroll 50. The scroll 50 includes an upper scroll 70 disposed on an upper portion of the lower scroll 60. The lower scroll 60 and the upper scroll 70 may be coupled. The scroll 50 may include a divider 80 that divides the interior of the scroll 50 into a lower portion and an upper portion. The scroll 50 may include the intake portion 90 coupled to a lower portion of the lower scroll 60. The inlet 91 through which air is drawn in may be formed in the intake portion 90. The inlet 91 may be provided in a plurality.

The lower scroll 60 may include a lower installation portion 61 in which the fan F is installed. The lower installation portion 61 may be formed in a circular shape. The intake portion 90 having the inlets 91 may be coupled to the lower installation portion 61. The lower installation portion 61 may form a first lower flow path 68 that is a portion of the lower flow path 67 formed by the lower scroll 60 and the divider 80. That is, the first lower flow path 68 may be formed by the lower installation portion 61 and the divider 80. Air drawn into the inlets 91 by the fan F may flow into the first lower flow path 68 formed by the lower installation portion 61 and the divider 80.

The lower scroll 60 may include a lower connection duct 63 connected to the lower installation portion 61. The outlet 65 through which air drawn into the scroll 50 is discharged may be formed in the lower connection duct 63. The lower connection duct 63 may form a second lower flow path 69 that is a portion of the lower flow path 67 formed by the lower scroll 60 and the divider 80. That is, the second lower flow path 69 may be formed by the lower connection duct 63 and the divider 80. The second lower flow path 69 may be in communication with the first lower flow path 68. The lower flow path 67 including the first lower flow path 68 and the second lower flow path 69 may be in communication with the outlet 65. The air drawn into the inlets 91 by the fan F may pass through the first and second lower flow paths 68 and 69 and be discharged through the outlet 65. That is, the air drawn into the inlets 91 by the fan F may pass through the lower flow path 67 and be discharged to the outlet 65. The air discharged through the outlet 65 may pass through the guide flow path 17 inside the guide duct 15 connected to the scroll 50 and dissipate heat from the heat sink 13. That is, the air drawn into the inlets 91 by the fan F may be guided to the heat sink 13 through the lower flow path 67 (See FIGS. 6 and 7).

The upper scroll 70 may include an upper installation portion 71 in which the fan F is installed. The upper installation portion 71 may be formed in a circular shape. The lower installation portion 61 of the lower scroll 60 may be coupled to a lower portion of the upper installation portion 71. The upper installation portion 71 may form a first upper flow path 78 that is a portion of the upper flow path 77 formed by the upper scroll 70 and the divider 80. That is, the first upper flow path 78 may be formed by the upper installation portion 71 and the divider 80. To explain this in more detail, the upper flow path 77 may be formed by the upper scroll 70, the divider 80, and the sheet coil seating plate 36 (see FIG. 5). Accordingly, the first upper flow path 78 may be formed by the upper installation portion 71, the divider 80, and the sheet coil seating plate 36 (see FIG. 5). Hereinafter, for ease of description, the upper flow path 77 will be described as being formed by the upper scroll 70 and the divider 80. The air drawn into the inlet 91 by the fan F may flow into the first upper flow path 78 formed by the upper installation portion 71 and the divider 80.

The upper scroll 70 may include an upper connection duct 73 connected to the upper installation portion 71. An opening 75 may be formed in the upper connection duct 73 through which air drawn into the scroll 50 is discharged into a space within the lower plate 30. The upper connection duct 73 may form a second upper flow path 79 that is a portion of the upper flow path 77 formed by the upper scroll 70 and the divider 80. That is, the second upper flow path 79 may be formed by the upper connection duct 73 and the divider 80. The second upper flow path 79 may be in communication with the first upper flow path 78. The air drawn into the inlets 91 by the fan F may pass through the first upper flow path 78 and flow through the second upper flow path 79. The second upper flow path 79 may be closed by the lower connection duct 63 at a portion opposite the portion in communication with the first upper flow path 78. The air flowing through the second upper flow path 79 may be discharged into the space within the lower plate 30 through the opening 75 to dissipate heat from the plurality of electrical components 11 (See FIGS. 6 and 7).

The divider 80 may be arranged in the upper scroll 70. The divider 80 may divide the interior of the scroll 50 into the lower flow path 67 and the upper flow path 77. The divider 80 may be arranged to be located centrally in the fan F in a vertical direction of the fan F. Although the divider 80 is shown in the drawings as being located at the center of the fan F in the vertical direction of the fan F, the present disclosure is not limited thereto. For example, the divider 80 may be located above the center of the fan F or below the center of the fan F, rather than at the center of the fan F in the vertical direction of the fan F.

Since the cooktop 10 of the cooking appliance uses the sheet coil 40, the air drawn into the inlets 91 by the fan F may dissipate heat through both the heat sink 13 and the sheet coil 40. However, the flow resistance of the flow path for heat dissipation of the heat sink 13 and the flow path resistance of the flow path for heat dissipation of the sheet coil 40 may be different from each other. That is, since the flow path for heat dissipation of the heat sink 13 only needs to dissipate heat from the heat sink 13, the flow path may be configured to direct air toward the heat sink 13. However, since the sheet coil 40 has an area similar to the total area of the lower plate 30, air may not be directed to any one place, and heat from the sheet coil 40 may be dissipated by forced convection of the air. As described above, the scroll 50 may be configured to be divided into the lower scroll 60 and the upper scroll 70 in order to supply air using a single fan F to the flow path for heat dissipation of the heat sink 13 and the flow path for heat dissipation of the sheet coil 40, which have different flow resistances (See FIGS. 5 and 7).

To supply air using the single fan F to each of the two flow paths with different flow resistances, the flow path for heat dissipation of the heat sink 13 and the flow path for heat dissipation of the sheet coil 40, the interior of the scroll 50 may be divided into the lower flow path 67 and the upper flow path 77 by the divider 80. Of the lower flow path 67 and the upper flow path 77, the lower flow path 67 may be used as the flow path for heat dissipation of the heat sink 13, and the upper flow path 77 may be used as the flow path for heat dissipation of the sheet coil 40. Of the flow path for heat dissipation of the heat sink 13 and the flow path for heat dissipation of the sheet coil 40, the flow path for heat dissipation of the sheet coil 40 using the forced convection method may have a relatively larger flow resistance. As a result, the upper flow path 77, which has a larger flow resistance, may receive a larger volume of air from the fan F than the lower flow path 67, which has a smaller flow resistance. To supply different volumes of air to the lower flow path 67 and the upper flow path 77 by the single fan F, the expansion angle A of the fan F in the lower flow path 67 and the upper flow path 77 may be different. Here, the expansion angle A of the fan F may be an angle between the blades of the fan F. The expansion angle A of the fan F may be set to gradually increase in a radial direction of the fan F from the center of the fan F.

To make the expansion angles A of the fan F different in the lower flow path 67 and the upper flow path 77, the lower flow path 67 and the upper flow path 77 may be arranged to have different lengths in the radial direction of the fan F from the center O of the fan F. The lower flow path 67 may be arranged such that the fan F has a first expansion angle. The upper flow path 77 may be arranged such that the fan F has a second expansion angle. The larger the expansion angle A of the fan F, the greater the volume of air that may be supplied by the fan F. The second expansion angle, which is the expansion angle A of the fan F in the upper flow path 77, may be larger than the first expansion angle, which is the expansion angle A of the fan F in the lower flow path 67 to allow the upper flow path 77, which has a larger flow resistance than the lower flow path 67, to receive a larger volume of air from the fan F. To this end, the first upper flow path 78 of the upper flow path 77 may be arranged to have a longer length in the radial direction of the fan F from the center O of the fan F than the first lower flow path 68 of the lower flow path 67. In other words, a length D1 from the center O of the fan F to the side wall of the upper installation portion 71 forming the first upper flow path 78 in the radial direction of the fan F may be arranged to be longer than a length D2 of the fan F from the center O of the fan F to the side wall of the lower installation portion 61 forming the first lower flow path 68 in the radial direction of the fan F.

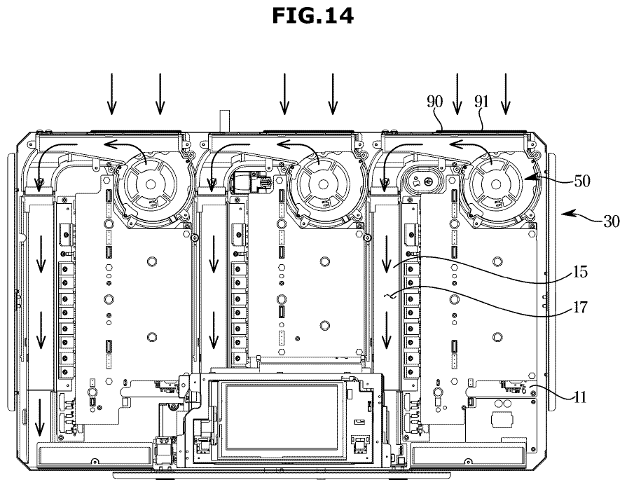

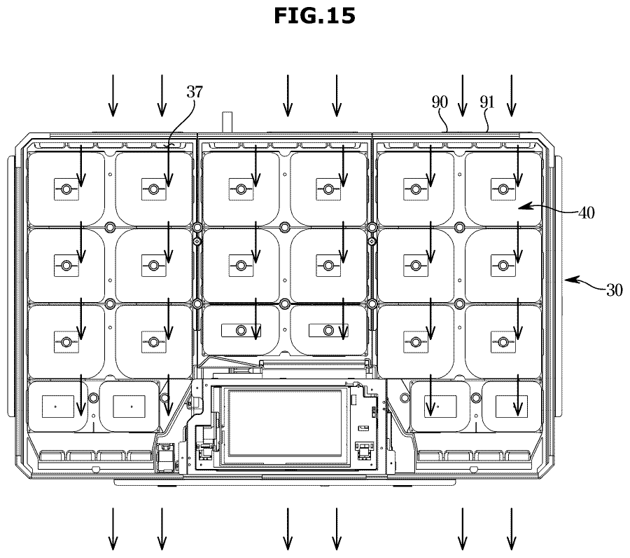

FIG. 13 is a cross-sectional view of the cooktop of the cooking appliance according to an embodiment. FIG. 14 is a view illustrating the flow of air that is drawn into the inlet to be moved along the first flow path to dissipate heat from the heat sink, according to an embodiment. FIG. 15 is a view illustrating the flow of air that is drawn into the inlet to be moved along the second flow path and then discharged after dissipating heat from the sheet coil, according to an embodiment.

As shown in FIGS. 13 to 15, the interior of the scroll 50 may be divided into the lower flow path 67 and the upper flow path 77 by the divider 80. A portion of the air drawn into the inlets 91 by the fan F may flow into the lower flow path 67, and a portion of the remaining portion may flow into the upper flow path 77. The air flowing into the lower flow path 67 may be discharged through the outlet 65 (see FIG. 8) and flow into the guide flow path 17 connected to the lower flow path 67. The air flowing into the guide flow path 17 may pass through the guide flow path 17 and dissipate heat from the heat sink 13. The air passing through the guide flow path 17 and dissipating heat from the heat sink 13 may be discharged to the outside through the first discharge holes 32 formed on the lower surface 31 of the lower plate 30. The lower flow path 67 of the scroll 50 and the guide flow path 17 of the guide duct 15, which are for heat dissipation of the heat sink 13, may form the first flow paths 15 and 67 (see FIGS. 3 and 7).

The gap G may be formed between the upper plate 20 and the sheet coil 40. The gap G formed between the upper plate 20 and the sheet coil 40 may be used as a flow path for heat dissipation of the sheet coil 40. The air drawn into the inlets 91 by the fan F to flow into the upper flow path 77 may be discharged through the discharge holes 37 into the gap G formed between the upper plate 20 and the sheet coil 40. The air discharged into the gap G formed between the upper plate 20 and the sheet coil 40 may pass through the gap G and dissipate heat from the sheet coil 40. The air dissipating heat from the sheet coil 40 may be discharged to the outside through the second discharge holes 35 formed on the side wall 34 of the lower plate 30 and the third discharge holes 33 formed on the lower surface 31 of the lower plate 30. The upper flow path 77 of the scroll 50 and the gap G formed between the upper plate 20 and the sheet coil 40, which are for dissipating heat from the sheet coil 40 may form the second flow paths 77 and G (see FIG. 3).

The air drawn into the inlets 91 by the fan F and flowing into the upper flow path 77 may be discharged through the discharge hole 37 and used to dissipate heat from the sheet coil 40, and a portion of the air drawn into the upper flow path 77 may be discharged into the space inside the lower plate 30 through the opening 75 formed in the upper connection duct 73 to dissipate heat from the plurality of electrical components 11. The air that has cooled the plurality of electrical components 11 may be discharged to the outside through the second discharge holes 35 formed in the side wall 34 of the lower plate 30 (see FIGS. 2 and 6).

The gap G formed between the upper plate 20 and the sheet coil 40 may be approximately 2.5 mm to 4.0 mm. In particular, the gap G formed between the upper plate 20 and the sheet coil 40 may be approximately 3.3 mm. When the gap G formed between the upper plate 20 and the sheet coil 40 is large, the flow path for dissipating heat from the sheet coil 40 may be increased. As a result, the volume of air supplied to the gap G formed between the upper plate 20 and the sheet coil 40 may be increased, heat dissipation of the sheet coil 40 may be performed more efficiently, but the magnetic force generated in the sheet coil 40 and transmitted to the upper plate 20 may be weakened. Furthermore, when the magnetic force generated in the sheet coil 40 and transmitted to the upper plate 20 is weakened, the amount of heat generated by the sheet coil 40 may be increased in order to transmit a correspondingly greater magnetic force to the upper plate 20.

Conversely, when the gap G formed between the upper plate 20 and the sheet coil 40 is small, the flow path for dissipating heat from the sheet coil 40 may become small. As a result, the volume of air supplied to the gap G formed between the upper plate 20 and the sheet coil 40 is reduced, it may be difficult for the heat dissipation of the sheet coil 40 to be efficient. Furthermore, when the gap G formed between the upper plate 20 and the sheet coil 40 is small, the magnetic force generated by the sheet coil 40 and transmitted to the upper plate 20 may become too strong. Accordingly, the magnetic force is also transmitted to the cooking vessel 1 placed on the upper plate 20, which may be dangerous for users to use.

Consequently, it may be necessary to properly adjust the gap G formed between the upper plate 20 and the sheet coil 40, because if the gap G formed between the upper plate 20 and the sheet coil 40 is small, the efficiency of the heat dissipation of the sheet coil 40 may be reduced, and if the gap G formed between the upper plate 20 and the sheet coil 40 is large, the efficiency of the heat dissipation of the sheet coil 40 may be good.

A cooking appliance according to an embodiment of the present disclosure includes the upper plate 20 on which the cooking vessel 1 is placed, the lower plate 30 disposed on the lower portion of the upper plate to include the discharge hole 37 and including the plurality of electrical components 11 and the heat sink 13 for dissipating heat generated in the plurality of electrical components, the sheet coil 40 disposed on the lower plate to form the gap G with the upper plate, the scroll 50 having the inlet 91 and the outlet 65 and forming the flow paths 67 and 77 for dissipating heat from the sheet coil and the heat sink by discharging air drawn in through the inlet to the discharge hole and the outlet, and the fan F disposed within the scroll to generate an intake force. The scroll includes the lower scroll 60 disposed on a lower portion of the scroll to allow the fan to have a first expansion angle and forming the lower flow path 67 to guide air drawn in through the inlet to the heat sink, the upper scroll 70 disposed on an upper portion of the lower scroll to allow the fan to have a second expansion angle greater than the first expansion angle and forming the upper flow path 77 to guide air drawn in through the inlet to the gap, and the divider 80 dividing the interior of the scroll into the lower flow path and the upper flow path. According to the present disclosure, to dissipate heat from the sheet coil and the heat sink, the interior of the scroll forming the flow paths for air drawn in by the fan is divided into the lower flow path and the upper flow path by the divider, so that the single fan may be used to dissipate heat from the sheet coil and the heat sink simultaneously. By setting the expansion angles of the fan in the lower flow path and the upper flow path divided by the divider, air of different volumes may be supplied to the lower flow path and the upper flow path.

The lower scroll may include the lower installation portion 61 on which the fan is installed and forming the first lower flow path 68 that is a portion of the lower flow path, the upper scroll may include the upper installation portion 71 on which the upper flow path is installed and forming the first upper flow path 78 that is a portion of the first upper flow path 78, and the first upper flow path has a longer length in the radial direction of the fan from the center O of the fan than the first lower flow path. It can be arranged to have a longer length. According to the present disclosure, by setting the expansion angles of the fan in the lower flow path and the upper flow path divided by the divider, air of different volumes may be supplied to the lower flow path and the upper flow path.

The outlet may communicate with the lower flow path, and the air drawn into the inlet may be discharged to the heat sink through the outlet.

The scroll may further include the intake portion 90 forming the inlet and coupled to the lower scroll.

The lower scroll may include the lower installation portion 61 to which the intake portion is coupled and the fan is installed, and the lower connection duct 63 connected to the lower installation portion and forming the outlet.

The lower flow path may include the first lower flow path 68 formed by the lower installation portion and the divider, and the second lower flow path 69 formed by the lower connection duct and the divider to connect the first lower flow path and the outlet.

The guide duct 15 connected to the lower connection duct may be provided on the upper portion of the heat sink, and the guide duct may form the guide flow path 17 that is in communication with the lower flow path to guide the air discharged through the outlet to dissipate heat from the heat sink. According to the present disclosure, the heat sink may be dissipated efficiently.

The lower flow path and the guide flow path may form the first flow paths 67 and 17 for heat dissipation of the heat sink. According to the present disclosure, the heat sink may be dissipated efficiently.

The lower plate may include the first discharge hole 32 formed on the lower surface 31 of the lower plate to allow the air passing through the first flow path and dissipating heat from the heat sink to be discharged to the outside.

The upper scroll may include the upper installation portion 71 in which the fan is installed, the upper connection duct 73 connected to the upper installation portion, and the opening 75 disposed in the upper connection duct to allow the air in the upper flow path to be discharged to dissipate heat from the plurality of electrical components. According to the present disclosure, the plurality of electrical components may be dissipated efficiently.

The upper installation portion may form the first upper flow path 78 that is a portion of the upper flow path together with the divider, and the upper connection duct may form the second upper flow path 79 that communicates with the first upper flow path together with the divider.

The lower plate may include the sheet coil seating plate 36 on which the sheet coil is seated and the discharge hole is formed. According to the present disclosure, the sheet coil may be dissipated efficiently.

The discharge hole may communicate with the upper flow path, and the air drawn into the inlet may be discharged into the gap through the discharge hole. According to the present disclosure, the sheet coil may be dissipated efficiently.

The upper flow path and the gap may form the second flow paths 77 and G for heat dissipation of the sheet coil. According to the present disclosure, the sheet coil may be dissipated efficiently.

The lower plate may include the second discharge hole 35 formed on the side wall 34 of the lower plate, and the second discharge hole may discharge to the outside the air passing through the second flow path and dissipating heat from the sheet coil and the air discharged through the opening and dissipating heat from the plurality of electrical components.

A cooking appliance according to an embodiment of the present disclosure may include the upper plate 20 on which the cooking vessel 1 is placed, the lower plate 30 disposed on the lower portion of the upper plate to include the discharge hole 37 and including the plurality of electrical components 11 and the heat sink 13 for dissipating heat generated in the plurality of electrical components, the sheet coil 40 disposed on the lower plate to form the gap G with the upper plate, the scroll 50 having the inlet 91 and the outlet 65 and forming the flow paths 67 and 77 for dissipating heat from the sheet coil and the heat sink by discharging air drawn in through the inlet to the discharge hole and the outlet, and the fan F disposed within the scroll to generate an intake force. The flow path may include the lower flow path 67 disposed on the lower portion of the scroll and allowing the air drawn into the inlet may be discharged into the outlet to dissipate heat from the heat sink, and the upper flow path 77 disposed on the upper portion of the lower flow path and allowing the air drawn into the inlet may be discharged into the outlet to dissipate heat from the seat coil. According to the present disclosure, to dissipate heat from the sheet coil and the heat sink, the interior of the scroll forming the flow paths for air drawn in by the fan may be divided into the lower flow path and the upper flow path by the divider, so that the single fan may be used to dissipate heat from the sheet coil and the heat sink simultaneously.

The guide duct 15 connected to the lower connection duct may be provided on the upper portion of the heat sink, and the guide duct may form the guide flow path 17 that is in communication with the lower flow path to guide the air discharged through the outlet to dissipate heat from the heat sink. According to the present disclosure, the heat sink may be dissipated efficiently.

The lower flow path and the guide flow path may form the first flow paths 67 and 17 that dissipate heat from the heat sink. According to the present disclosure, the heat sink may be dissipated efficiently.

The upper flow path and the gap may form the second flow path 77 and G that dissipate heat from the sheet coil. According to the present disclosure, heat may be dissipated efficiently.

The gap may be 2.5 mm to 4.0 mm.

The effects to be obtained from the present disclosure are not limited to those mentioned above, and other effects not mentioned will be apparent to those having ordinary knowledge in the art to which the present disclosure belongs from the following description.

While the present disclosure has been particularly described with reference to exemplary embodiments, it should be understood by those of skilled in the art that various changes in form and details may be made without departing from the spirit and scope of the present disclosure.

1. A cooking appliance, comprising:
an upper plate on which a cooking vessel is placeable;
a lower plate below the upper plate, and including:
a discharge hole,
electrical components, and
a heat sink configured to dissipate heat generated by the electrical components;
a sheet coil on the lower plate, and spaced apart from the upper plate so as to form a gap between the sheet coil and the upper plate, the sheet coil configured to generate a magnetic field to heat the cooking vessel;
a scroll including:
an inlet,
an outlet,
a lower scroll on a lower portion of the scroll and at least partially forming a lower flow path from the inlet and along the heat sink, and
an upper scroll on an upper portion of the scroll and at least partially forming an upper flow path from the inlet and through the gap; and
a fan within the scroll, the fan including blades having a first expansion angle in the lower flow path and a second expansion angle greater than the first expansion angle in the upper flow path, the fan operable to generate a flow of air from the inlet to the discharge hole,
wherein the fan and the scroll are configured such that, with the fan operated to generate the flow of air, a first portion of the flow of air is guided by the lower scroll along the lower flow path to remove the heat dissipated by the heat sink through the discharge hole, and a second portion of the flow of air is guided by the upper scroll along the upper flow path to remove heat generated by the sheet coil through the discharge hole.

2. The cooking appliance of claim 1, wherein
the lower scroll includes a lower installation portion in which the fan is installed and which forms at least a portion of a first lower flow path that is a portion of the lower flow path,
the upper scroll includes an upper installation portion in which the fan is installed and which forms at least a portion of a first upper flow path that is a portion of the upper flow path, and
a length of the first upper flow path from a center of the fan in a radial direction of the fan is longer than a length of the first lower flow path from the center of the fan in the radial direction.

3. The cooking appliance of claim 1, wherein
the lower flow path includes the outlet, and
with the fan operated to generate the flow of air, air is drawn into the inlet and the first portion of the flow of air includes at least a portion of the air drawn into the inlet which is discharged through the outlet to the heat sink.

4. The cooking appliance of claim 3, wherein the scroll further includes an intake portion including the inlet and that is coupled to the lower scroll.

5. The cooking appliance of claim 4, wherein the lower scroll includes:
a lower installation portion to which the intake portion is coupled and in which the fan is installed, and
a lower connection duct connected to the lower installation portion and that includes the outlet.

6. The cooking appliance of claim 5, wherein
the scroll further includes a divider, and
the lower flow path includes:
a first lower flow path at least partially formed by the lower installation portion and the divider, and
a second lower flow path that connects the first lower flow path and the outlet, the second lower flow path at least partially formed by the lower connection duct and the divider.

7. The cooking appliance of claim 6, further comprising:
a guide duct connected to the lower connection duct and on an upper portion of the heat sink,
wherein the guide duct forms a guide flow path that is part of the lower flow path and the guide duct is configured such that, with the fan operated to generate the flow of air, the air discharged through the outlet is guided by the guide duct to the heat sink to remove the heat dissipated by the heat sink.

8. The cooking appliance of claim 7, wherein a first flow path includes the lower flow path and the guide flow path, and the first flow path is configured to remove the heat dissipated by the heat sink.

9. The cooking appliance of claim 8, wherein
the discharge hole is through a lower surface of the lower plate, and
the discharge hole is configured such that, with the fan operated to generate the flow of air, at least a portion of the first portion of the flow of air removes the heat dissipated by the heat sink and is discharged to an outside of the cooking appliance through the discharge hole.

10. The cooking appliance of claim 1, wherein the upper scroll includes:
an upper installation portion in which the fan is installed,
an upper connection duct connected to the upper installation portion, and
an opening in the upper connection duct, the opening configured such that, with the fan operated to generate the flow of air, at least a portion of the second portion of the flow of air is discharged through the opening to the electrical components to remove heat generated by the electrical components.

11. The cooking appliance of claim 10, wherein
the scroll further includes a divider, and
the upper flow path includes:
a first upper flow path at least partially formed by the upper installation portion and the divider, and
a second upper flow path that connects the first upper flow path and the gap, the second upper flow path at least partially formed by the upper connection duct and the divider.

12. The cooking appliance of claim 11, wherein the lower plate further includes a sheet coil seating plate on which the sheet coil is seated and through which the discharge hole is formed.

13. The cooking appliance of claim 12, wherein
the upper flow path includes the discharge hole, and
with the fan operated to generate the flow of air, air is drawn into the inlet and the second portion of the flow of air includes at least a portion of the air drawn into the inlet which is discharged through the discharge hole into the gap.

14. The cooking appliance of claim 13, wherein a second flow path includes the upper flow path and the gap, and the second flow path is configured to remove the heat generated by the sheet coil.

15. The cooking appliance of claim 14, wherein
the discharge hole is a first discharge hole,
the lower plate further includes a second discharge hole through a side wall of the lower plate, and
the second discharge hole is configured such that, with the fan operated to generate the flow of air, a first part of the second portion of the flow of air removes the heat generated by the sheet coil, a second part of the second portion of the flow of air passes through the opening and removes the heat generated by the electrical components, and the first part and the second part are discharged to an outside of the cooking appliance through the second discharge hole.
